(19) United States
(12) Patent Application Publication
(10) Pub. No.: US 2014/0104974 A1
(43) Pub. Date: Apr. 17, 2014

(54) METHOD AND APPARATUS FOR MEASURING OUT AND AGITATING BLENDER INGREDIENTS

(71) Applicant: Tribest Corporation, Anaheim, CA (US)

(72) Inventors: Jae Kyoung Choi, La Habra Heights, CA (US); William Wooram Choi, Los Angeles, CA (US)

(21) Appl. No.: 13/653,326

(22) Filed: Oct. 16, 2012

(51) Int. Cl. B01F 15/00

(52) U.S. Cl. 366/142

(57) ABSTRACT

Described herein is a blender with an agitator having a built-in measuring spoon. In one embodiment, the device may include a base unit having a motorized drive, as well as a container extending from a lower portion to an upper portion. The lower portion may have rotatable blade(s) engaged with the motorized drive. The device may also include a cover removably attached to the upper portion, wherein the cover has a cover opening. The device may further include an elongate agitator extending from a proximal portion to a distal portion, wherein the distal portion is insertable through the cover opening and has a measuring spoon with at least one graduated marking to denote at least one known volume.

### BACKGROUND

1. Field

The present disclosure relates generally to an ingredient measurer and agitator for a food blender.

2. Background

Numerous kitchen appliances and tools may be needed to prepare a meal or even a single food item. One popular kitchen appliance is the blender or food mixer, which may be used to prepare various food items, including smoothies, juices, sauces, etc. Detailed recipes for certain food items may require numerous ingredients, which in turn may require numerous tools to measure and prepare the ingredients.

The use of more kitchen tools with the blender may create more clutter in the kitchen and result in having to spend more time to clean the kitchen tools after preparing the food items. Accordingly, there remains a need for an all-in-one design for the blender and tools that are typically used with the blender.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more aspects of the embodiments described herein, there is provided a mixing device or blender assembly with an agitator having a built-in measuring spoon. For example, the device may include a base unit having a motor coupled to a drive mechanism, as well as a jar extending from a lower portion to an open upper portion for receiving ingredients. The lower portion may have a rotatable blade assembly engageable by the drive mechanism. The device may also include a top cover removably attached to the open upper portion, wherein the cover has a cover opening. The device may further include an elongate agitator extending from a proximal portion to a distal portion, wherein the distal portion is insertable through the cover opening and has a measuring spoon with at least one graduated marking to denote at least one defined volume within the measuring spoon for measuring out one or more of the ingredients to be placed into the jar. The proximal portion may include a user handle.

In accordance with one or more aspects of the embodiments described herein, there is provided a method for using a blender having a motorized base unit and a blending container. The method may involve measuring out at least one ingredient to be added into the container with a measuring spoon on one end of an elongate agitator, the measuring spoon having at least one graduated marking to denote at least one defined volume. The method may involve adding the at least one defined volume of the at least one ingredient into to the container with the measuring spoon on the agitator. The method may further involve activating the motorized base unit to blend the at least one ingredient, and agitating the at least one ingredient with the agitator.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a partially exploded view of an exemplary embodiment of a blender with an elongate agitator-measuring spoon apparatus inside of the blender jar.

FIG. 2A is a first perspective view of an example agitator-measuring spoon apparatus in accordance with the aspects described herein.

FIG. 2B is a top plan view of the example agitator-measuring spoon apparatus in FIG. 2A.

FIG. 2C is a side view of the example agitator-measuring spoon apparatus in FIG. 2A.

FIG. 2D is a bottom plan view of the example agitator-measuring spoon apparatus in FIG. 2A.

FIG. 2E is a distal end view of the example agitator-measuring spoon apparatus in FIG. 2A.

FIG. 2F is a proximal end view of the example agitator-measuring spoon apparatus in FIG. 2A.

FIG. 3 shows another example of an agitator-measuring spoon apparatus in accordance with the aspects described herein.

FIGS. 4A-4B show another example of an agitator-measuring spoon apparatus in accordance with the aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

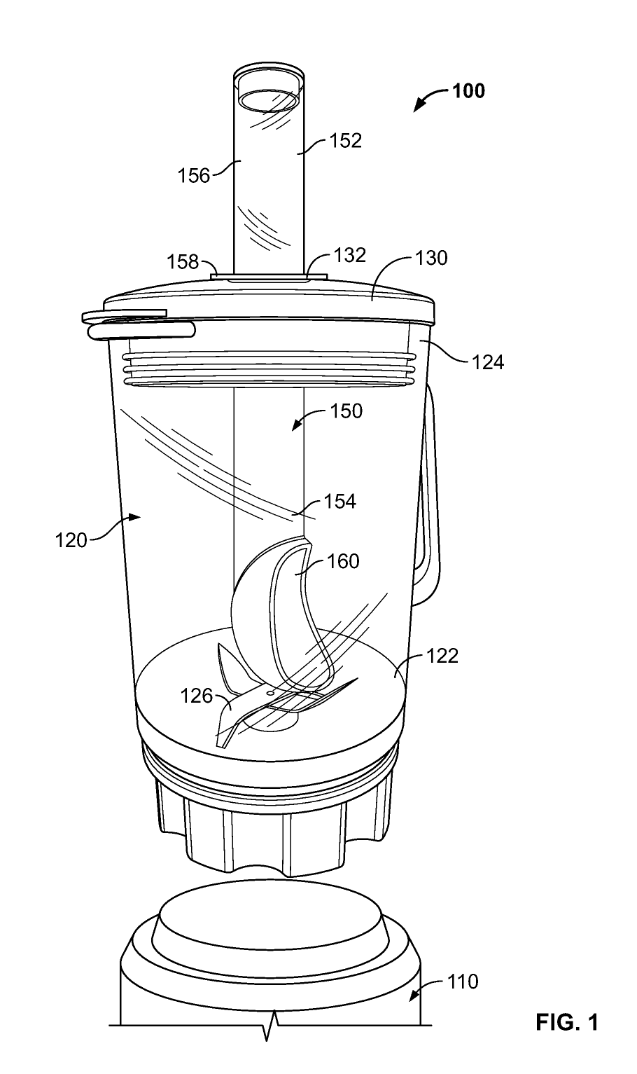

In accordance with aspects of the subject of this disclosure, FIG. 1 shows an example blender 100, which may also be referred to as a food mixer, processor, or the like. The blender 100 may include a base unit 110, which in turn may include a motor and a drive mechanism that are coupled to each other. The motor may include or be coupled to a power supply source, such as, for example, an alternating current (AC) power source and/or batteries. The blender 100 may also include a jar 120, which may also be referred to as a blending container, pitcher, or the like. The jar 120 may take the form of various shapes or configurations, in addition to the shape shown in the example of FIG. 1.

The jar 120 may have a lower portion 122 and an open upper portion 124. One or more ingredients may be added into the jar via the opening defined by the open portion 124. The lower portion 122 may include a rotatable blade assembly 126 or cutting portion that includes one or more rotatable blades or cutters. The rotatable blade assembly 126 may engage with the drive mechanism of the base unit 110. When activated, the motor of the base unit 110 causes the drive mechanism to rotate, thereby causing the blade assembly 126 to rotate and cut-up the ingredient(s) at or near the lower portion 122 of the jar 120.

The blender 100 may include a top cover 130 at the open upper portion 124. The top cover 130 may include a cover opening 132 of a defined size or diameter. The top cover 130 may removably attach to and cover the open upper portion 124, thereby preventing the ingredients or contents inside the jar 120 from spilling out during the blending process.

The blender 100 may include or be used with an elongate agitator 150, which may also be referred to as a plunger or stirrer. The agitator 150 may extend from a proximal portion 152 to a distal portion 154, and may have a measuring spoon 160 at or near the distal portion 154. The measuring spoon 160 may also be referred to as a measuring dispenser, measuring cup portion, or the like. Such an all-in-one type design eliminates the need to have a separate measuring spoon and agitator/plunger during operation of the blender.

As explained in further detail below, the measuring spoon 160 may have one or more graduated markings or lines that denote one or more defined volumes within the measuring spoon 160 for measuring out one or more of the ingredients to be placed into the jar 120. For example, the ingredient(s) may be added into the jar 120 via the open upper portion 124 with the cover 130 removed. In the alternative, or in addition, the ingredient(s) may be added into the jar 120 via the cover opening 132 with the cover 130 on top of the jar 120.

The distal portion 154, including the measuring spoon 160, may be insertable through the cover opening 132. The measuring spoon 160 may be inserted through the cover opening 132 to facilitate delivery of the ingredient(s) to the lower portion 122 of the jar 120. In one application, it may be desirable to place certain ingredient(s) into particular sections or areas within the lower portion 122, such as, for example, after the blending process has started and/or when the cover 130 cannot be removed (e.g., according to a recipe or due to safety considerations). For example, the measuring spoon 160 may be used to measure out and place certain ingredient(s) into particular areas within the lower portion 122 (e.g., with the cover 130 on the jar 120) according to a given recipe so that the blended content has a desired taste/flavor, consistency, or aesthetic effect (e.g., when colored ingredients are used).

Once inserted through the cover opening 132, the measuring spoon 160 of the elongate agitator 150 may also be used to more effectively agitate, plunge, or stir the ingredients inside the jar 120. In the alternative, or in addition, the measuring spoon 160 may be used to agitate, plunge, or stir the ingredients with the cover 130 removed.

It is noted that the measuring spoon 160 may be used to taste the blended ingredient(s), to remove certain debris or unwanted portions of the blended ingredient(s), and/or to clean the inside of the jar 120 (e.g., in tight spaces beneath the blades of the rotatable assembly 126 near the lower portion 122). It is also noted that the proximal portion 152 of the agitator 150 have include a user handle 156, gripper, or the like.

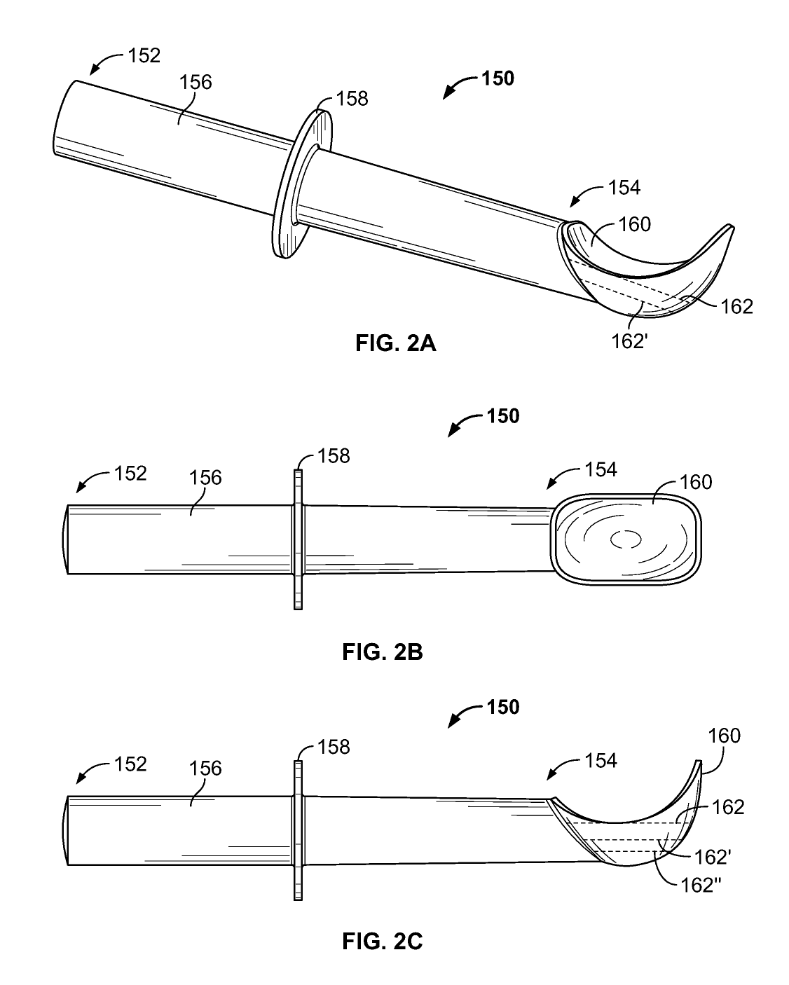

With reference to FIGS. 2A-2F, there are shown different views of an exemplary embodiment of an elongate agitator 150 with a measuring spoon 160 as a unitary structure. As explained above, the agitator 150 may extend from a proximal portion 152 to a distal portion 154, and may at least one measuring spoon 160 with at least one graduated marking (e.g. marking 162) to denote at least one known volume of the measuring spoon 160. The measuring spoon 160 may have one or more graduated markings, such as, for example, marking(s) 162, 162′, 162″, etc.

The user may hold the agitator 150 by a handle 156 on the distal portion 152 and measure out a desired volume of a given ingredient with measuring spoon 160. The user may place the desired volume of the given ingredient into the jar 120 with the measuring spoon 160, and may agitate the jar contents with the measuring spoon 160.

In related aspects, the agitator 150 may have a transverse collar 158 to prevent the agitator 150 from falling too far through the cover hole 132 and into the jar 120 or from hitting the rotatable blade assembly 126 during operation of the blender 100. The collar 158 may be located between the user handle 156 and the measuring spoon 160. The collar 158 may be dimensioned to have a larger diameter or size than the cover opening 132 to prevent the agitator 150 from falling too deeply through the cover hole 132 and into the jar 120 or from hitting the rotatable blade assembly 126 or the like.

In further related aspects, when the distal portion 154 of the agitator 150 is inserted through the cover opening 132, the collar 158 will be located proximally relative to the cover opening 132 (i.e., between the cover opening 132 of the cover 130 and the handle 156 of the agitator 150).

In yet further related aspects, the collar 158 may removably connect and/or lock with a connector portion (e.g., snap or twist fit) of the cover 130 (not shown). In the alternative, or in addition, the collar 158 may simply sit above the cover 130 when the distal portion 154 is inserted through the cover opening 132.

In still further related aspects, the agitator 150 may be formed of a plastic material. In the alternative, the agitator 150, or portions thereof, may be formed of another material, including but limited to steel, fiberglass, wood, or any other suitable material known of ordinary skill in the art.

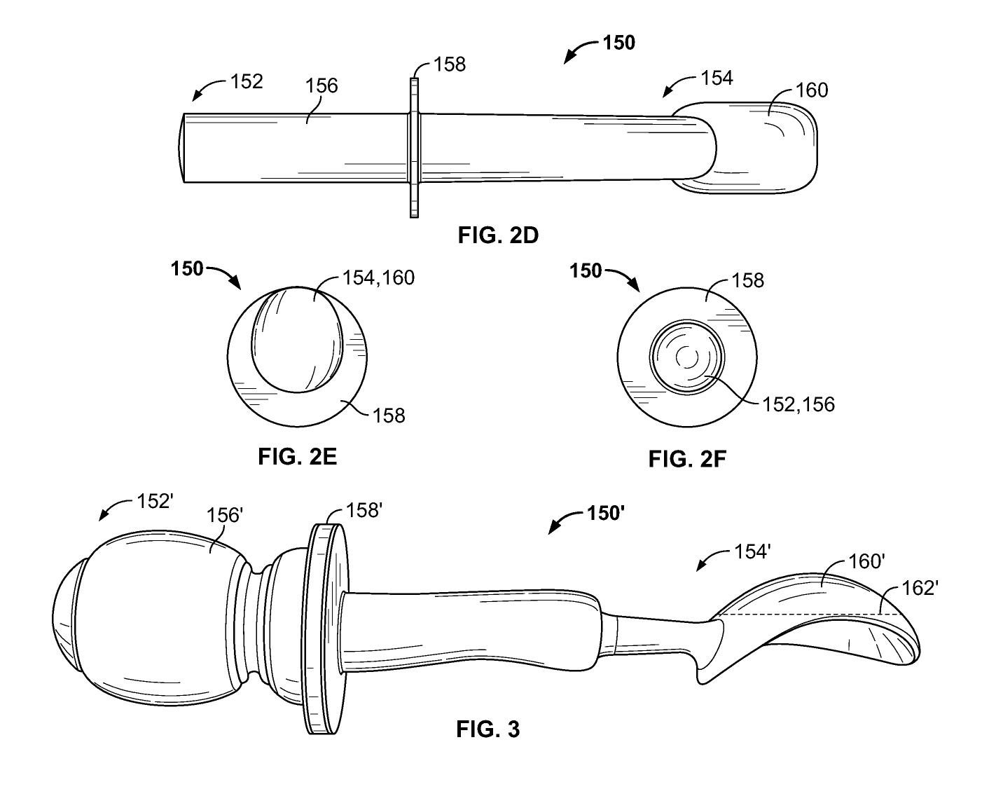

FIG. 3 shows another exemplary embodiment of an elongate agitator 150′ with a measuring spoon 160′. For example, the measuring spoon 160′ may be made from metal, the handle 156′ may be made from wood, and the collar 158′ may be made from plastic.

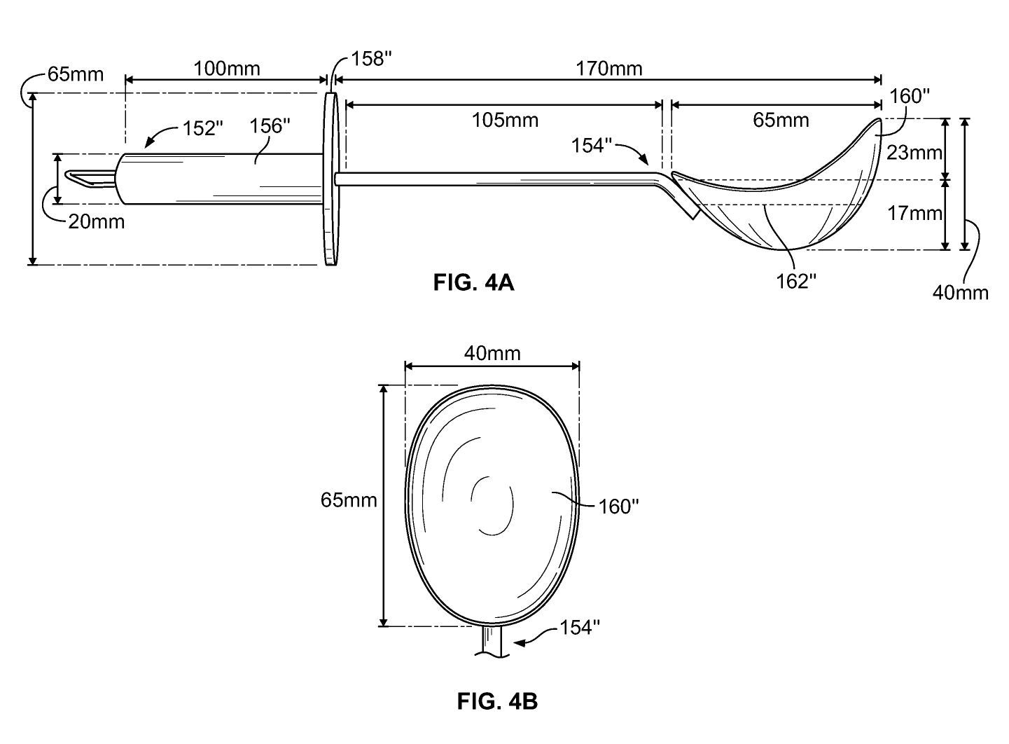

FIGS. 4A-4B illustrate yet another exemplary embodiment of an elongate agitator 150″ with a measuring spoon 160″. For example, the entire agitator 150″ and components thereof may be from steel. Example dimensions for the components of the agitator 150″ are shown in FIGS. 4A-4B.

In related aspects, the elongate agitator 150 may have one or more measuring spoons 150 at or near the distal portion 154. For example, two measuring spoons 150 may be placed back-to-back at the distal portion 154. In another example, two or more spoons may be placed side-by-side. In yet another example, a first spoon may be located proximally relative to a second spoon.

In accordance with one or more aspects of the embodiments described herein, there is provided a methodology for using a blender with an improved agitator that has a built-in measuring spoon. The method may involve measuring out at least one ingredient to be added into the container with a measuring spoon on one end of an elongate agitator, wherein the measuring spoon has at least one graduated marking to denote at least one defined volume. The method may involve adding the at least one defined volume of the at least one ingredient into to the container with the measuring spoon that is built into the agitator. The method may further involve activating the motorized base unit to blend the at least one ingredient. The method may also involve agitating the at least one ingredient with the agitator.

In related aspects, the method may additionally involve tasting a blended content in the container with the measuring spoon on the agitator. The method may optionally involve cleaning a bottom portion of the container with the measuring spoon on the agitator.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A mixing device, comprising:
a base unit having a motor coupled to a drive mechanism;
ajar extending from a lower portion to an open upper portion for receiving ingredients, the lower portion having a rotatable blade assembly engageable by the drive mechanism;
a top cover removably attached to the open upper portion, the cover comprising a cover opening; and
an elongate agitator extending from a proximal portion to a distal portion, the distal portion insertable through the cover opening and comprising a measuring spoon with at least one graduated marking to denote at least one defined volume within the measuring spoon for measuring out one or more of the ingredients to be placed into the jar, the proximal portion comprising a user handle.

2. The device of claim 1, wherein the agitator further comprises a transverse collar between the user handle and the measuring spoon, the collar having a larger diameter than the cover opening and being located proximally relative to the cover opening.

3. An assembly, comprising:
(a) a blender, comprising:
a base unit having a motorized drive;
a container extending from a lower portion to an upper portion, the lower portion having at least one rotating blade engaged with the motorized drive; and
a cover removably attached to the upper portion, the cover comprising a cover opening; and
(b) an elongate agitator extending from a proximal portion to a distal portion, the distal portion insertable through the cover opening and comprising a measuring spoon with at least one graduated marking to denote at least one known volume of the measuring spoon.

4. The assembly of claim 3, wherein the proximal portion of the agitator comprises a user handle.

5. The assembly of claim 3, wherein the agitator further comprises a transverse collar that is larger than the cover opening and located proximally relative to the cover opening.

6. The assembly of claim 5, wherein the collar removably connects to a connector portion of the cover.

7. A method for using a blender having a motorized base unit and a blending container, the method comprising:
measuring out at least one ingredient to be added into the container with a measuring spoon on one end of an elongate agitator, the measuring spoon having at least one graduated marking to denote at least one defined volume;
adding the at least one defined volume of the at least one ingredient into to the container with the measuring spoon on the agitator;
activating the motorized base unit to blend the at least one ingredient; and
agitating the at least one ingredient with the agitator.

8. The method of claim 7, further comprising tasting a blended content in the container with the measuring spoon on the agitator.

9. The method of claim 7, further comprising cleaning a bottom portion of the container with the measuring spoon on the agitator.
